(19) United States
(12) Patent Application Publication
(10) Pub. No.: US 2022/0090313 A1
(43) Pub. Date: Mar. 24, 2022

(54) METHOD FOR PRODUCING THERMAL INSULATION SHEET

(71) Applicant: Panasonic Intellectual Property Management Co., Ltd., Osaka (JP)

(72) Inventors: YASUTAKA HANASHIRO, Hokkaido (JP); RYOSUKE USUI, Hokkaido (JP); CHIHIRO SATOU, Osaka (JP); YUJI YAMAGISHI, Hokkaido (JP)

(21) Appl. No.: 17/413,928

(22) PCT Filed: Oct. 10, 2019
(86) PCT No.: PCT/JP2019/039947

§ 371 Date: Jun. 14, 2021

(30) Foreign Application Priority Data
Mar. 19, 2019 (JP) 2019-050576

(51) Int. Cl. D06M 10/06; C01B 33/16

(52) U.S. Cl. CPC D06M 10/06; H01M 10/658; C01B 33/16

(57) ABSTRACT

A fiber sheet having first and second surfaces and spaces therein is prepared. The spaces of the fiber sheet are impregnated with silica sol containing water glass and ethylene carbonate. Silica gel is formed by causing the silica sol with which the spaces of the fiber sheet is impregnated to gel while a difference between respective temperatures at the first and surfaces of the fiber sheet is equal to or larger than 50° C. The silica gel is hydrophobized, thereby providing a thermal insulation sheet. In the thermal insulation sheet, compressibilities of the first and second surfaces for a predetermined pressure applied thereto are different from each other. The thermal insulation sheet may be disposed between two battery cells so as to prevent one sell from influencing the other even if the one expands.

### TECHNICAL FIELD

The present invention relates to a method of manufacturing thermal insulation sheets to be used as measures for thermal insulation.

### BACKGROUND ART

In recent years, needs for energy saving have been increased. Among the ways to satisfy such needs are measures for increase in energy efficiency by keeping equipment warm. In secondary battery in which battery cells are combined, there are requests for thermal insulation between the battery cells in order that one battery cell having become hot is prevented from affecting neighboring battery cells. As a measure for this, thermal insulation sheets having an excellent thermal insulation effect may be adopted between the battery cells.

Such a thermal insulation sheet is disclosed in, e.g. PTL 1.

### CITATION LIST

### Patent Literature

PTL 1: Japanese Patent Laid-Open Publication No. 2011-136859

### SUMMARY

A fiber sheet having first and second surfaces and spaces therein is prepared. The spaces of the fiber sheet are impregnated with silica sol containing water glass and ethylene carbonate. Silica gel is formed by causing the silica sol with which the spaces of the fiber sheet is impregnated to gel while a difference between respective temperatures at the first and surfaces of the fiber sheet is equal to or larger than 50° C. The silica gel is hydrophobized, thereby providing a thermal insulation sheet.

In the thermal insulation sheet, compressibilities of the first and second surfaces for a predetermined pressure applied thereto are different from each other. The thermal insulation sheet may be disposed between two battery cells so as to prevent one sell from influencing the other even if the one expands.

### BRIEF DESCRIPTION OF DRAWINGS

FIG. 1 is a cross-sectional view of a thermal insulation sheet according to an exemplary embodiment.

FIG. 2 is a cross-sectional view of the thermal insulation sheet according to the embodiment for illustrating a method of manufacturing the thermal insulation sheet.

FIG. 3 is a cross-sectional view of a secondary battery including the thermal insulation sheet according to the embodiment.

### DETAIL DESCRIPTION OF PREFERRED EMBODIMENT

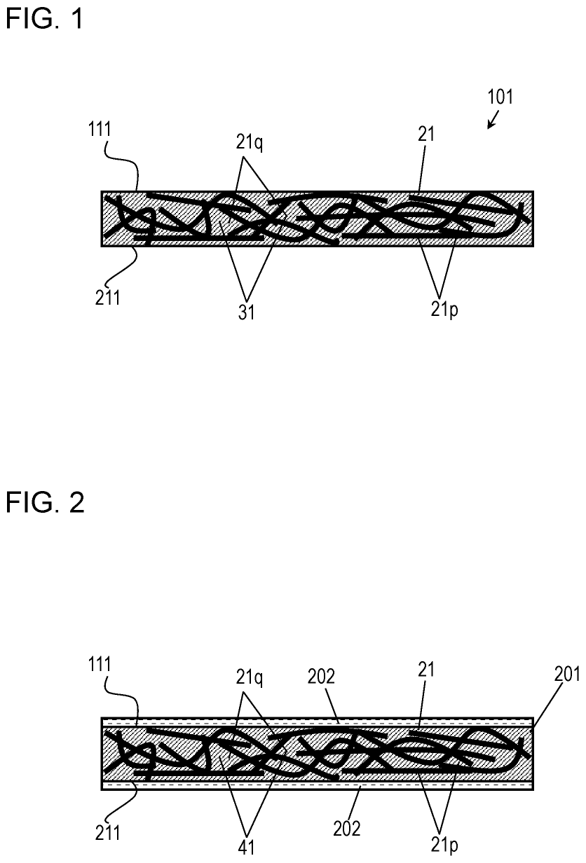

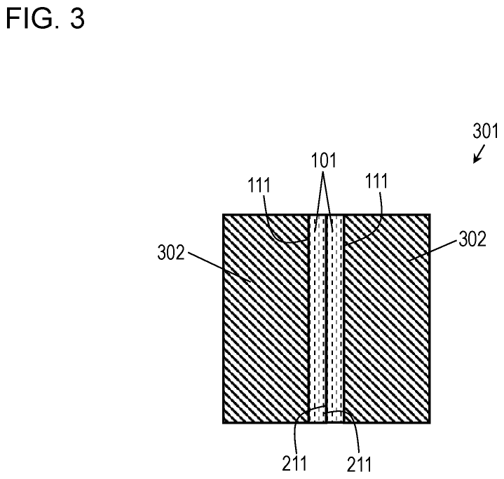

FIG. 1 is a cross-sectional view of thermal insulation sheet 101 according to an exemplary embodiment. Thermal insulation sheet 101 includes fiber sheet 21 having spaces 21q in the inside of the fiber sheet and silica gel 31 with which spaces 21q of fiber sheet 21 by are impregnated. A method of manufacturing thermal insulation sheet 101 will be described below. FIG. 2 is a cross-sectional view of thermal insulation sheet 101 for illustrating the method of manufacturing thermal insulation sheet 101. First, fiber sheet 21 having spaces 21q in its inside is prepared. Fiber sheet 21 has a thickness of about 1 mm, and has a rectangular shape of about 80 mm×150 mm. Fiber sheet 21 is made of glass fibers 21p having an average fiber thickness of about 2 μm. Glass fibers 21p are entangled with one another so as to form spaces 21q among the fibers. According to the embodiment, fiber sheet 21 has a weight per unit area of approximately 130 g/m2 per 1 mm thickness. Fiber sheet 21 has surfaces 111 and 211 opposite to each other.

Next, a preparation of impregnation of spaces 21q in the inside of fiber sheet 21 with silica gel 31 constituting a silica xerogel is made. As a material of silica gel 31, silica sol 41 is prepared by adding about 6% ethylene carbonate, as a catalyst, to about 20% water glass. Fiber sheet 21 is immersed in silica sol 41, thereby impregnating spaces 21q in the inside of fiber sheet 21 with silica sol 41 to produce material sheet 201.

Next, material sheet 201 impregnated with silica sol 41 is pressed to have a uniform thickness. The uniform thickness may be obtained by another method, such as roll pressing. In order to reinforce its gel skeleton, material sheet 201 with the uniform thickness is cured while the sheet is sandwiched by films 202, thereby causing silica sol 41 to gel to change into silica gel 31 being silica xerogel. During the curing, material sheet 201 is left at a constant temperature such that silica sol 41 gels while silica sol 41 is held in spaces 21q of fiber sheet 21, thereby causing the resulting gel to grow further. In addition, material sheet 201 sandwiched by the films prevents evaporation of silica sol 41. In the gelation, material sheet 201 is left for about 10 minutes in the following conditions: surface 111 of fiber sheet 21 is directed upward in the vertical direction; surface 211 is directed downward in the vertical direction, i.e. is directed in the direction of gravity; surface 111 is kept at about 90° C.; and surface 211 is kept at about 20° C. Since the ethylene carbonate is added as a catalyst to the water glass, the hydrolysis reaction rapidly proceeds when the temperature exceeds 85° C., the gelation of silica sol 41 proceeds while part of the silica is eluted. For this reason, the content of silica gel in a portion of silica sol 41 with a higher temperature decreases more than in a portion of silica sol 41 with a lower temperature, resulting in an increase in the compressibility of the portion of silica gel 31 with the higher temperature for a pressure applied thereto. On the contrary, dehydration condensation of the portion of silica sol 41 with the lower temperature proceeds more than that of the portion of silica sol 41 with the higher temperature, hence causing silica sol 41 to gel as it is, resulting in a decrease in the compressibility of the portion of silica gel 31 with the lower temperature.

Next, silica gel 31 is hydrophobized by the following procedure. Fiber sheet 21 impregnated with silica gel 31 is immersed in hydrochloric acid 6N for about 30 minutes, thereby causing silica gel 31 to react with the hydrochloric acid. After that, fiber sheet 21 impregnated with silica gel 31 is immersed in silylation solution that is mixture solution of silylating agent and alcohol, and then, stored in a constant temperature bath at about 55° C. for about 2 hours. Through the procedure, the mixture solution of the silylating agent and the alcohol permeates into silica gel 31. When trimethylsiloxane bonds start to form as the reaction proceeds, the hydrochloric acid water is discharged to the outside from fiber sheet 21 impregnated with silica gel 31. After the completion of the silylation, silica gel 31 is dried in a constant temperature bath at about 150° C. for about 2 hours, thereby providing thermal insulation sheet 101.

Respective temperatures at surfaces 111 and 211 of fiber sheet 21, i.e. material sheet 201, may be differentiated from each other by the following procedure. For example, the fiber sheet is held for a predetermined period of time with surface 211 facing downward, i.e. facing in the direction of gravity, while surface 211 of material sheet 201 impregnated with silica sol 41 is placed on a cooling plate kept at a low temperature and surface 111 contacts a heating plate kept at a high temperature. Alternatively, surface 111 may be heated by irradiating surface 111 with infrared ray.

In this way described above, the gel skeleton is reinforced by causing silica sol 41 to gel while the difference of the temperatures at surfaces 111 and 211 is equal to or larger than 50° C., thereby providing a large difference in compressibility between respective portions of the fiber sheet near surfaces 111 and surface 211.

Material sheet 201 is preferably cured while surface 111 is directed upward in the vertical direction and the temperature at surface 111 is higher than the temperature at surface 211. Surface 111 having a higher temperature than surface 211 accelerates the hydrolysis reaction near surface 111 more than near surface 211, causing a part of the silica to be eluted, followed by travelling toward surface 211 by gravity. This configuration produces a large difference in compressibility between respective portions of thermal insulation sheet 101 near surfaces 111 and surface 211.

In the gelation, the temperature at surface 111 is preferably equal to or higher than 85° C. and is equal to or lower than 135° C. The temperature of surface 111 lower than 85° C. less proceed the hydrolysis reaction. The temperature of surface 111 higher than 135° C. excessively rises the reaction rate, causing larger variations in the reaction.

In thermal insulation sheet 101 obtained in this way described above, the portion of the sheet near surface 111 which have been kept at the high temperature exhibits high compressibility, and the portion thereof near surface 211 which have been kept at the low temperature exhibits low compressibility.

FIG. 3 is a cross-sectional view of secondary battery 301 according to the embodiment. Secondary battery 301 includes battery cells 302 and two thermal insulation sheets 101 disposed between battery cells 302. Two thermal insulation sheets 101 are disposed between battery cells 302 while surfaces 211 of the sheets facing each other. Surfaces 111 of thermal insulation sheets 101 face respective battery cells 302. Since surfaces 111 of thermal insulation sheets 101 exhibit high compressibility, when one of battery cells 302 generates heat and expands, the expansion of the cell is absorbed by the portions the sheets with high compressibility near surface 111 of thermal insulation sheets 101 while the thermal insulation is held by the portions of the sheets with low compressibility near surface 211. This configuration prevents the heat from affecting the other battery cell 302, the neighboring one, thereby preventing thermal runaway. In secondary battery 301 according to the embodiment, two thermal insulation sheets 101 are disposed between battery cells 302; however, instead of two thermal insulation sheets 101, only single thermal insulation sheet 101 which is folded may be disposed such that portions of surface 211 face each other.

Toward the end of life of a secondary battery, the central portions of the battery cells expand due to, e.g. gases generated inside the battery cells. In conventional thermal insulation sheets in each of which silica xerogel is supported at uniform density in a fiber sheet, in the case where such thermal insulation sheets are too hard, the sheets cannot sufficiently absorb the cells' swelling. On the contrary, in the case where such thermal insulation sheets are too soft, compressing the sheets causes a decrease in their heat insulating properties. This causes a possible problem that, when a certain battery cell becomes hot, such a cell affects the neighboring battery cell.

In contrast, thermal insulation sheet 101 according to the embodiment used in secondary battery 301 prevents an influence of heat from one battery cell 302 caused by the heat and expansion of the cell to the neighboring battery cell 302, thereby preventing thermal runaway.

### REFERENCE MARKS IN THE DRAWINGS

21 fiber sheet
31 silica gel
41 silica sol
101 thermal insulation sheet

1. A method of manufacturing a thermal insulation sheet, comprising:
preparing a fiber sheet having a first surface and a second surface opposite to the first surface, the fiber sheet including spaces inside the fiber sheet;
impregnating the spaces of the fiber sheet with silica sol containing water glass and ethylene carbonate;
forming silica gel by causing the silica sol with which the spaces of the fiber sheet is impregnated to gel while a difference between a temperature at the first surface of the fiber sheet and a temperature at the second surface of the fiber sheet is equal to or larger than 50° C.; and
hydrophobizing the silica gel.

2. The method of claim 1, wherein said forming the silica gel comprises forming the silica gel by causing the silica sol to gel with which the spaces of the fiber sheet is impregnated while the second surface of the fiber sheet is directed in a direction of gravity and the temperature at the first surface of the fiber sheet is higher than the temperature of the second surface of the fiber sheet.

3. The method of claim 2, wherein said forming the silica gel comprises forming the silica gel by causing the silica sol with which the spaces of the fiber sheet is impregnated to gel while the second surface is directed in the direction of gravity, the temperature at the first surface of the fiber sheet is higher than the temperature at the second surface of the fiber sheet, and the temperature at the first surface of the fiber sheet is equal to or higher than 85° C. and equal to or lower than 135° C.
